(19) United States
(12) Patent Application Publication
(10) Pub. No.: US 2019/0315184 A1
(43) Pub. Date: Oct. 17, 2019

(54) VEHICULAR HEAT MANAGEMENT SYSTEM

(71) Applicant: Hanon Systems, Daejeon (KR)

(72) Inventors: Doo Hoon KIM, Daejeon (KR); Hyeon Gyu KIM, Daejeon (KR); Kyung Ju AN, Daejeon (KR); Sang Jun YOO, Daejeon (KR); Joong Man HAN, Daejeon (KR)

(21) Appl. No.: 16/385,491

(22) Filed: Apr. 16, 2019

(30) Foreign Application Priority Data
Apr. 17, 2018 (KR) 10-2018-0044323
Mar. 28, 2019 (KR) 10-2019-0035861

(51) Int. Cl. B60H 1/00

(52) U.S. Cl. CPC B60H 1/00035; B60H 1/00385; B60H 2001/00185; B60H 2001/00307; B60H 1/00885

(57) ABSTRACT

A vehicular heat management system includes a refrigerant circulation line, a cooling water circulation line configured to heat a passenger compartment with waste heat of an engine by allowing cooling water of the engine to circulate through a heater core, and a hot air supply source selection unit configured to, when a hot air needs to be supplied into the passenger compartment in an air conditioner mode in which a refrigerant in the refrigerant circulation line flows through a compressor, an outdoor heat exchanger, an expansion valve and an indoor heat exchanger so as to cool the passenger compartment with a cold air generated by the refrigerant in the indoor heat exchanger, select one of heat generated from the refrigerant in the compressor and heat generated from the cooling water in the engine, as a hot air supply source for supplying the hot air into the passenger compartment.

### CROSS-REFERENCE TO RELATED PATENT APPLICATIONS

This application claims the benefit of Korean Patent Application Nos. 10-2018-0044323 filed Apr. 17, 2018 and 10-2019-0035861 filed Mar. 28, 2019, which are hereby incorporated herein by reference in their entirety.

### TECHNICAL FIELD

The present invention relates to a vehicular heat management system and, more particularly, to a vehicular heat management system capable of supplying hot air into a passenger compartment without operating an engine during an air conditioner mode, minimizing the operation of an engine while not deteriorating the comfort in the passenger compartment, and enhancing the fuel efficiency of a vehicle.

### BACKGROUND ART

A hybrid vehicle is a vehicle that uses an electric motor and an internal combustion engine in combination. When the hybrid vehicle is running at a high load, for example, when the hybrid vehicle is running at a high speed or on an uphill, the hybrid vehicle comes into an engine driven mode in which an engine is used.

Conversely, the hybrid vehicle is running at a low load, for example, when the hybrid vehicle is running at a low speed or stopped, the hybrid vehicle comes into a motor driven mode in which an electric motor is used.

Such a hybrid vehicle (hereinafter generally referred to as “vehicle”) is equipped with an air conditioner for cooling and heating a passenger compartment.

As shown in FIG. 1, the air conditioner is provided with a compressor 1, a condenser 3, an expansion valve 5, an evaporator 6 and a heater core 7. In a cooling mode, the refrigerant of the compressor 1 is circulated through the condenser 3, the expansion valve 5 and the evaporator 6 to generate a cold air in the evaporator 6. The cold air thus generated is supplied into the passenger compartment to cool the passenger compartment.

In a heating mode, the cooling water for an engine 8 is circulated through the heater core 7 to transfer the waste heat of the engine 8 to the heater core 7 to generate hot air. The hot air thus generated is supplied into the passenger compartment to heat the passenger compartment.

Meanwhile, the air conditioner may often come into the heating mode while the vehicle is operated in the motor driven mode. In this case, the motor driven mode is converted into an engine driven mode to re-operate the engine 8.

Thus, the passenger compartment can be heated using the waste heat generated from the engine 8. This makes it possible to enhance the passenger compartment heating performance.

However, in such a conventional air conditioner, there may be a case where the entry and release of the heating mode are frequently generated in the motor driven mode. In this case, the engine 8 needs to be frequently turned on and off. Thus, the power consumption is increased and the temperature of the air blown into the passenger compartment is changed, resulting in a problem that the comfort of the passenger compartment is deteriorated.

Particularly, since the engine 8 is frequently turned on and off, the energy consumption is rapidly increased, which causes a drawback that the fuel efficiency of the vehicle is remarkably lowered.

In view of this, the air conditioner may be improved into a heat pump type. The heat pump type air conditioner (not shown) is used for a cooling purpose or a heating purpose while being controlled in an air conditioner mode or a heat pump mode according to a flow direction of a refrigerant. The heat pump type air conditioner makes it possible to heat a passenger compartment without re-operating an engine in a passenger compartment heating mode. This makes it possible to improve the fuel efficiency of a vehicle.

However, the heat pump type air conditioner cannot cope with a situation where a hot air needs to be supplied into a passenger compartment to increase a passenger compartment temperature in an air conditioner mode.

Particularly, under a mild ambient air temperature condition, there may be a need to simultaneously operate an air conditioner and a heater to supply a cold air of the air conditioner and a hot air of the heater into a passenger compartment. However, the conventional heat pump type air conditioner cannot comply with such a situation.

Therefore, even if the air conditioner is improved into a heat pump type, it is still required to operate the engine when a hot air needs to be supplied into a passenger compartment during an air conditioner mode. Due to such a problem, the energy consumption is still high and, consequently, the fuel efficiency of a vehicle is lowered.

### SUMMARY

In view of the aforementioned problems inherent in the related art, it is an object of the present invention to provide a vehicular heat management system capable of supplying a hot air into a passenger compartment without operating an engine during an air conditioner mode, minimizing the energy consumption and improving the comfort in the passenger compartment.

Another object of the present invention is to provide a vehicular heat management system capable of operating an engine when there is a need to supply a hot air into a passenger compartment during an air conditioner mode and minimizing the operation of the engine without deteriorating the comfort in the passenger compartment.

A further object of the present invention is to provide a vehicular heat management system capable of minimizing the energy consumption and improving the fuel efficiency of a vehicle.

According to one aspect of the present invention, there is provided a vehicular heat management system, including: a refrigerant circulation line; a cooling water circulation line configured to heat a passenger compartment with waste heat of an engine by allowing cooling water of the engine to circulate through a heater core; and a hot air supply source selection unit configured to, when a hot air needs to be supplied into the passenger compartment in an air conditioner mode in which a refrigerant in the refrigerant circulation line flows through a compressor, an outdoor heat exchanger, an expansion valve and an indoor heat exchanger so as to cool the passenger compartment with a cold air generated by the refrigerant in the indoor heat exchanger, select one of heat generated from the refrigerant in the compressor and heat generated from the cooling water in the engine, as a hot air supply source for supplying the hot air into the passenger compartment.

In the system, the hot air supply source selection unit may include: a water-cooled heat exchanger configured to transfer heat generated from the refrigerant having a high pressure and a high temperature in the compressor of the refrigerant circulation line to the cooling water of the cooling water circulation line; a water pump and a flow control valve configured to generate a flow of the cooling water in the cooling water circulation line and to control the flow of the cooling water so that the waste heat of the engine is transferred to the heater core by allowing the cooling water to circulate between the engine and the heater core or so that the heat of the water-cooled heat exchanger is transferred to the heater core by allowing the cooling water to circulate between the water-cooled heat exchanger and the heater core; and a control unit configured to control the water pump and the flow control valve so as to supply hot air generated by the waste heat of the engine due to the circulation of the cooling water between the engine and the heater core or hot air generated by the heat of the refrigerant circulation line due to the circulation of the cooling water between the water-cooled heat exchanger and the heater core, into the passenger compartment.

In the system, the control unit may be configured to control the water pump and the flow control valve so as to perform one of the supply of the hot air into the passenger compartment using the heat of the refrigerant circulation line and the supply of the hot air into the passenger compartment using the heat of the cooling water of the engine, according to a cooling water discharge temperature on an outlet side of the engine and a refrigerant discharge temperature on an outlet side of the compressor.

In the system, the control unit may be configured to control the water pump and the flow control valve so as to perform one of the supply of the hot air into the passenger compartment using the heat of the refrigerant circulation line and the supply of the hot air into the passenger compartment using the heat of the cooling water of the engine, according to a temperature difference between the cooling water discharge temperature and the refrigerant discharge temperature under a condition that the cooling water discharge temperature on the outlet side of the engine is equal to or lower than the refrigerant discharge temperature on the outlet side of the compressor.

In the system, the control unit may be configured to, if the temperature difference between the cooling water discharge temperature and the refrigerant discharge temperature exceeds a predetermined reference temperature difference, control the water pump and the flow control valve to allow the cooling water to circulate between the water-cooled heat exchanger and the heater core so that the heat of the refrigerant circulation line is used as the hot air supply source and, if the temperature difference between the cooling water discharge temperature and the refrigerant discharge temperature is equal to or smaller than the reference temperature difference, control the water pump and the flow control valve to allow the cooling water to circulate between the engine and the heater core so that the waste heat of the engine is used as the hot air supply source.

According to the vehicular heat management system according to the present invention, it is possible to supply hot air into a passenger compartment without operating an engine during an air conditioner mode.

Furthermore, it is possible to minimize the operation of an engine without deteriorating the comfort in a passenger compartment.

In addition, it is possible to enhance the fuel efficiency of a vehicle and to improve the comfort in a passenger compartment.

### BRIEF DESCRIPTION OF THE DRAWINGS

FIG. 1 is a view showing a conventional vehicular air conditioner.

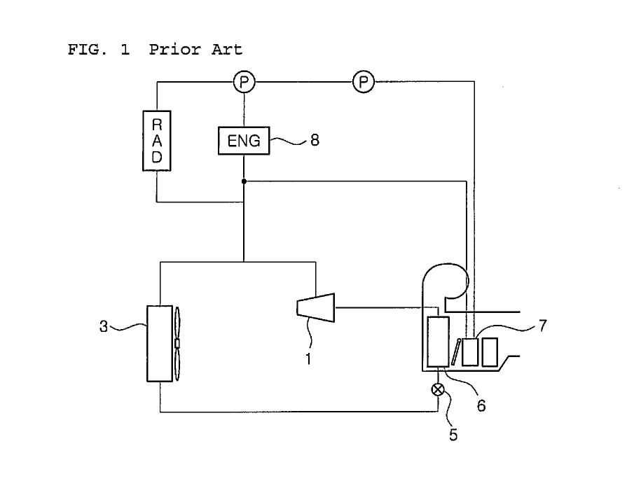

FIG. 2 is a view showing a vehicular heat management system according to a first embodiment of the present invention.

FIG. 3 is a view showing an example of the operation of the vehicular heat management system according to the first embodiment of the present invention, wherein a hot air is supplied into a passenger compartment using the heat of a heat pump without resort to the waste heat of an engine.

FIG. 4 is a view showing an example of the operation of the vehicular heat management system according to the first embodiment of the present invention, wherein a hot air is supplied into a passenger compartment using the waste heat of an engine.

FIG. 5 is a flowchart showing an example of the operation of the vehicular heat management system according to the first embodiment of the present invention.

FIG. 6 is a view showing a vehicular heat management system according to a second embodiment of the present invention.

FIG. 7 is a view showing an example of the operation of the vehicular heat management system according to the second embodiment of the present invention, wherein a hot air is supplied into a passenger compartment using the heat of a heat pump without resort to the waste heat of an engine.

FIG. 8 is a view showing an example of the operation of the vehicular heat management system according to the second embodiment of the present invention, wherein a hot air is supplied into a passenger compartment using the waste heat of an engine.

### DETAILED DESCRIPTION

Preferred embodiments of a vehicular heat management system according to the present invention will now be described in detail with reference to the accompanying drawings.

### First Embodiment

Referring first to FIG, 2, the heat management system according to the present invention includes an air conditioner. The air conditioner is of a heat pump type and includes a refrigerant circulation line 10 and a cooling water circulation line 20.

The refrigerant circulation line 10 includes a compressor 12, a water-cooled heat exchanger 14, a heat pump mode expansion valve 15, an outdoor heat exchanger 16, an air conditioner mode expansion valve 17 and an indoor heat exchanger 19.

During a passenger compartment cooling mode, the refrigerant circulation line 10 is controlled in an air conditioner mode to form a refrigerant circulation loop constituted by the compressor 12, the water-cooled heat exchanger 14, the outdoor heat exchanger 16, the air conditioner mode expansion valve 17 and the indoor heat exchanger 19.

Specifically, the refrigerant discharged from the compressor 12 is primarily condensed while passing through the water-cooled heat exchanger 14 and is secondarily condensed while passing through the outdoor heat exchanger 16. The refrigerant is depressurized and expanded while passing through the expansion valve 17. When the refrigerant passes through the indoor heat exchanger 19, a cold air having a low temperature is generated to cool the passenger compartment.

During a passenger compartment heating mode, the heat pump side refrigerant circulation line 10 is controlled in a heat pump mode to form a refrigerant circulation loop constituted by the compressor 12, the water-cooled heat exchanger 14, the heat pump mode expansion valve 15 and the outdoor heat exchanger 16. By way of this refrigerant circulation loop, the heat having a high temperature is generated in the water-cooled heat exchanger 14 and is transferred to the cooling water circulation line 20. Thus, the high-temperature heat transferred to the cooling water circulation line 20 is radiated into the passenger compartment through a heater core 22, thereby heating the passenger compartment.

The water-cooled heat exchanger 14 includes a refrigerant flow path 14a through which the refrigerant in the refrigerant circulation line 10 is circulated and a cooling water flow path 14b through which the cooling water in the cooling water circulation line 20 is circulated.

The refrigerant flow path 14a and the cooling water flow path 14b are formed to correspond to each other so that the refrigerant in the refrigerant circulation line 10 and the cooling water in the cooling water circulation line 20 can exchange heat with each other.

Specifically, when the vehicle enters the heating mode while being controlled in a motor driven mode, the high-temperature refrigerant on the side of the water-cooled heat exchanger 14 of the refrigerant circulation line 10 and the cooling water in the cooling water circulation line 20 exchange heat with each other.

Accordingly, the heat of the water-cooled heat exchanger 14 of the refrigerant circulation line 10 is transferred to the cooling water in the cooling water circulation line 20. The cooling water heated by the heat is circulated through the heater core 22 to heat the passenger compartment.

Furthermore, when a hot air needs to be supplied into the passenger compartment in a state in which the refrigerant circulation line 10 is controlled in an air conditioner mode, the refrigerant flow path 14a and the cooling water flow path 14b enable the high-temperature refrigerant on the side of the water-cooled heat exchanger 14 of the refrigerant circulation line 10 and the cooling water in the cooling water circulation line 20 to exchange heat with each other.

Accordingly, the heat on the side of the water-cooled heat exchanger 14 of the refrigerant circulation line 10 is transferred to the cooling water in the cooling water circulation line 20 and is radiated into the passenger compartment through the heater core 22. Thus, the hot air can be supplied into the passenger compartment even when the refrigerant circulation line 10 is controlled in the air conditioner mode.

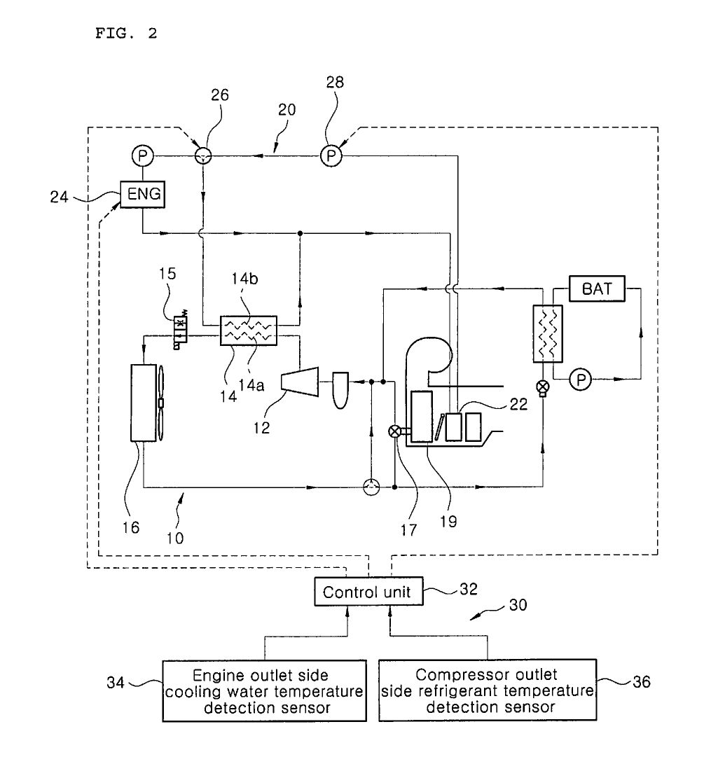

Referring again to FIG. 2, the cooling water circulation line 20 connects the heater core 22, the engine 24 and the water-cooled heat exchanger 14 of the refrigerant circulation line 10 to each other. The cooling water is circulated through the heater core 22, the engine 24 and the water-cooled heat exchanger 14 by a water pump 28. The cooling water circulation line 20 includes a flow control valve 26 for bringing the heater core 22 into communication with the engine 24 or bringing the heater core 22 into communication with the water-cooled heat exchanger 14.

The flow control valve 26 is a three-way control valve and is installed at a branch point between the engine 24 and the water-cooled heat exchanger 14.

In the passenger compartment heating mode, the three-way flow control valve 26 brings the heater core 22 into communication with the engine 24 to form a cooling water circulation loop between the heater core 22 and the engine 24, or brings the heater core 22 into communication with the water-cooled heat exchanger 14 to form a cooling water circulation loop between the heater core 22 and the water-cooled heat exchanger 14.

Therefore, in the passenger compartment heating mode, the cooling water is circulated between the engine 24 and the heater core 22 to heat the passenger compartment with the waste heat of the engine 24, or the cooling water is circulated between the water-cooled heat exchanger 14 and the heater core 22 to heat the passenger compartment with the heat generated in the water-cooled heat exchanger 14.

Furthermore, when a hot air needs to be supplied into the passenger compartment in a state in which the refrigerant circulation line 10 is controlled in the air s conditioner mode, the three-way flow control valve 26 brings the heater core 22 into communication with the water-cooled heat exchanger 14 to form a cooling water circulation loop between the heater core 22 and the water-cooled heat exchanger 14.

Accordingly, the high-temperature refrigerant on the side of the water-cooled heat exchanger 14 of the refrigerant circulation line 10 and the cooling water in the cooling water circulation line 20 can exchange heat with each other.

Therefore, the heat on the side of the water-cooled heat exchanger 14 of the refrigerant circulation line 10 is transferred to the cooling water in the cooling water circulation line 20 and is radiated into the passenger compartment through the heater core 22. Thus, the hot air can be supplied into the passenger compartment even when the refrigerant circulation line 10 is controlled in the air conditioner mode.

Referring again to FIG. 2, the vehicular heat management system according to the present invention includes a hot air supply source selection unit 30 configured to select one of the waste heat of the engine 24 and the heat of the water-cooled heat exchanger 14 as a hot air supply source when a hot air needs to be supplied into the passenger compartment in a state in which the refrigerant circulation line 10 is controlled in the air conditioner mode, for example, when a cold air and a hot air need to be simultaneously supplied into the passenger compartment under a mild ambient air condition.

The hot air supply source selection unit 30 includes a control unit 32 provided with a microprocessor. In a state in which the refrigerant circulation line 10 is controlled in the air conditioner mode, the hot air supply source selection unit 30 compares a cooling water discharge temperature inputted from an engine outlet side cooling water temperature detection sensor 34 with a refrigerant discharge temperature inputted from a compressor outlet side refrigerant temperature detection sensor 36.

If the result of comparison indicates that the cooling water discharge temperature in the engine 24 is lower than the refrigerant discharge temperature in the compressor 12, the control unit 32 compares a temperature difference between the cooling water discharge temperature and the refrigerant discharge temperature with a predetermined reference temperature difference, for example, 10 degrees C.

If the temperature difference between the cooling water discharge temperature and the refrigerant discharge temperature exceeds the reference temperature difference, for example, 10 degrees C., the control unit 32 recognizes that the hot air can be supplied into the passenger compartment using the heat of the water-cooled heat exchanger 14.

When such recognition is made, the control unit 32 enters a heat pump side hot air supply mode to control the flow control valve 26 and the water pump 28 of the cooling water circulation line 20 to bring the water-cooled heat exchanger 14 of the refrigerant circulation line 10 into communication with the heater core 22.

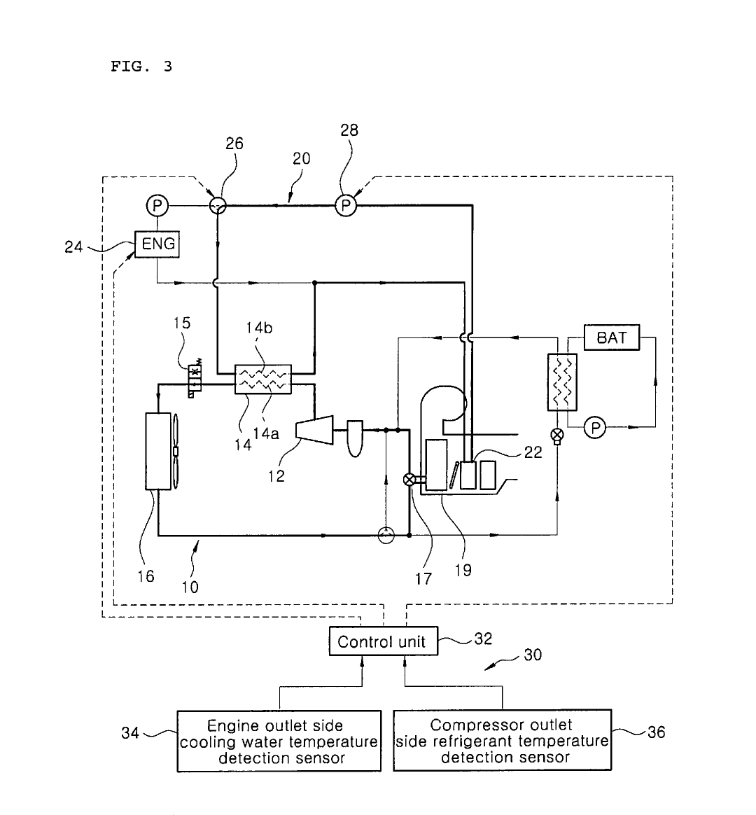

Therefore, as shown in FIG. 3, a cooling water circulation loop is formed between the heater core 22 and the water-cooled heat exchanger 14, the heat of the water-cooled heat exchanger 14 is transferred to the heater core 22 through the cooling water circulation loop, and a hot air is supplied into the passenger compartment using the heat of the water-cooled heat exchanger 14 transferred to the heater core 22.

As a result, the control unit 32 makes it possible to supply a hot air into the passenger compartment even when the refrigerant circulation line 10 is controlled in the air conditioner mode. Specifically, the control unit 32 makes it possible to supply hot air into the passenger compartment during the air conditioner mode without operating the engine 24.

Consequently, it is possible to minimize the operation of the engine 24 without deteriorating the comfort in the passenger compartment. This makes it possible to enhance the fuel efficiency of a vehicle and to improve the comfort in the passenger compartment.

On the other hand, if the temperature difference between the cooling water discharge temperature and the refrigerant discharge temperature is equal to or lower than the reference temperature difference, for example, 10 degrees C., the control unit 32 recognizes that a hot air cannot be supplied into the passenger compartment using the heat of the water-cooled heat exchanger 14.

When such recognition is made, the control unit 32 enters an engine side hot air supply mode to control the flow control valve 26 and the water pump 28 of the cooling water circulation line 20 to bring the engine 24 into communication with the heater core 22.

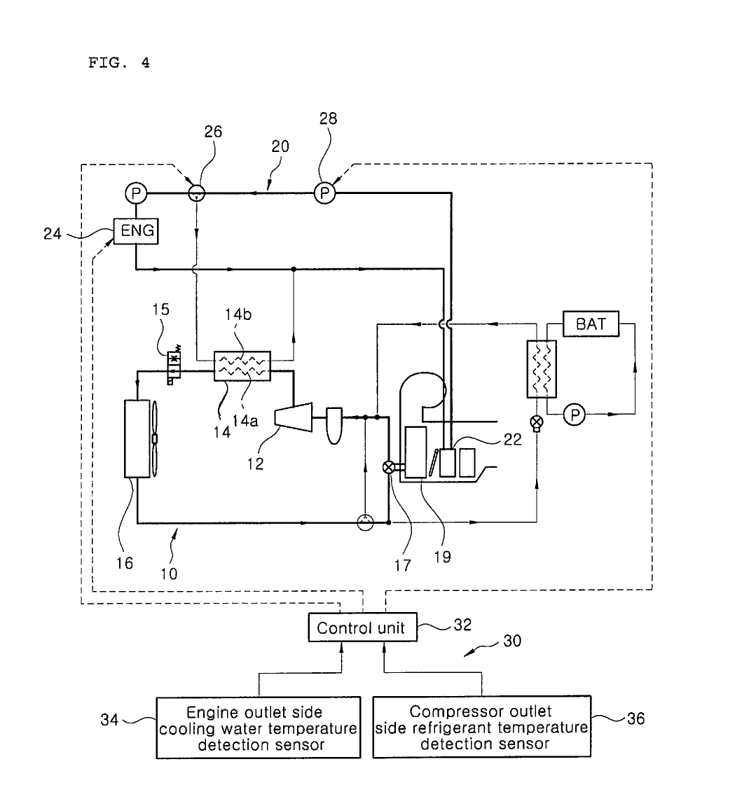

Therefore, as shown in FIG. 4, a cooling water circulation loop is formed between the heater core 22 and the engine 24, the waste heat of the engine 24 is transferred to the heater core 22 through the cooling water circulation loop, and a hot air is supplied into the passenger compartment using the waste heat of the engine 24 transferred to the heater core 22.

Consequently, the control unit 32 supplies a hot air into the passenger compartment using the waste heat of the engine 24 only when the temperature of the heat of the water-cooled heat exchanger 14 is low and has a small difference from the temperature of the waste heat of the engine 24.

Accordingly, the use of the waste heat of the engine 24 can be minimized as far as possible. Specifically, when the refrigerant circulation line 10 is controlled in the air conditioner mode, a hot air can be supplied into the passenger compartment using the heat of the water-cooled heat exchanger 14 without resort to the waste heat of the engine 24.

As a result, it is possible to minimize the operation of the engine 24 without deteriorating the comfort in the passenger compartment. This makes it possible to enhance the fuel efficiency of a vehicle and to improve the comfort in the passenger compartment.

Next, an example of the operation of the vehicular heat management system having the configuration described above will be described with reference to FIGS. 2 to 5.

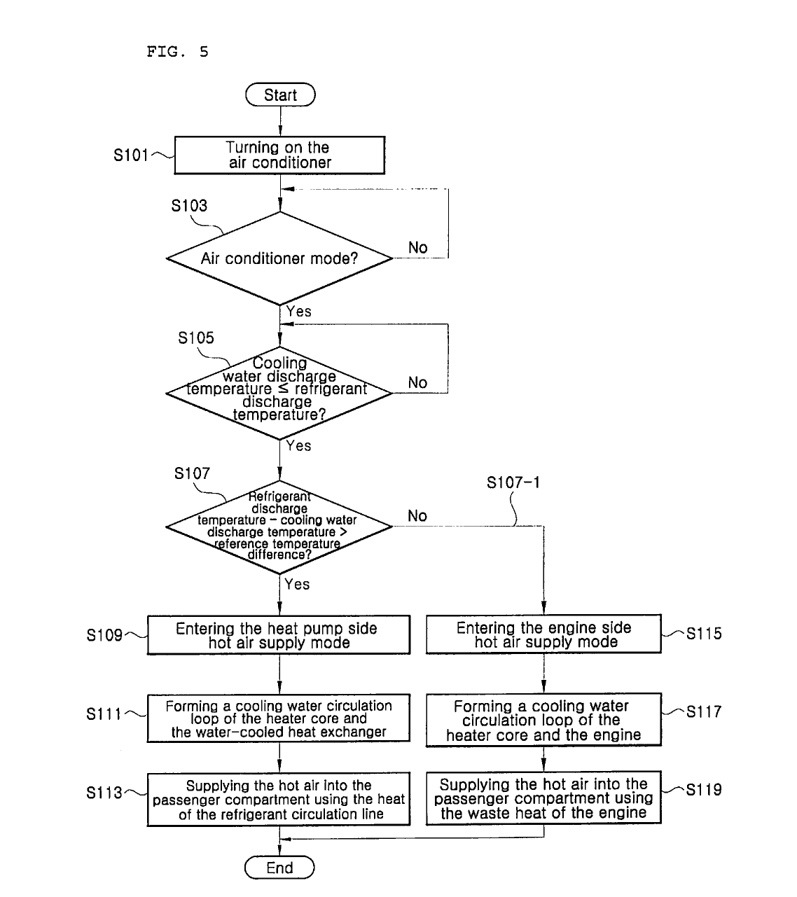

Referring first to FIGS. 5 and 2, the refrigerant circulation line 10 of the air conditioner is turned on (S101). In this state, the control unit 32 determines whether the refrigerant circulation line 10 is currently controlled in the air conditioner mode (S103).

If it is determined that the refrigerant circulation line 10 is controlled in the air conditioner mode, the control unit 32 determines whether the cooling water discharge temperature of the engine 24 is equal to or lower than the refrigerant discharge temperature of the compressor 12 (S105).

If it is determined that the cooling water discharge temperature is equal to or lower than the refrigerant discharge temperature, the control unit 32 determines whether the temperature difference between the cooling water discharge temperature and the refrigerant discharge temperature exceeds the reference temperature difference, for example, 10 degrees C. (S107).

If it is determined that the temperature difference between the cooling water discharge temperature and the refrigerant discharge temperature exceeds the reference temperature difference, for example, 10 degrees C., the control unit 32 enters a heat pump side hot air supply mode (S109).

In the heat pump side hot air supply mode, the control unit 32 controls the flow control valve 26 and the water pump 28 of the cooling water circulation line 20 as shown in FIG. 3, thereby forming a cooling water circulation loop constituted by the heater core 22 and the water-cooled heat exchanger 14 of the refrigerant circulation line 10 (S111). By way of the cooling water circulation loop thus formed, the heat of the water-cooled heat exchanger 14 of the refrigerant circulation line 10 is transferred to the heater core 22 so that a hot air can be supplied into the passenger compartment (S113).

Therefore, the hot air can be supplied into the passenger compartment even when the refrigerant circulation line 10 is controlled in the air conditioner mode. In other words, the hot air can be supplied into the passenger compartment during the air conditioner mode without operating the engine 24.

On the other hand, if it is determined in step S107 that the temperature difference between the cooling water discharge temperature and the refrigerant discharge temperature does not exceed the reference temperature difference (S107-1), namely if it is determined in step S107 that the temperature difference between the cooling water discharge temperature and the refrigerant discharge temperature is equal to or smaller than the reference temperature difference, for example, 10 degrees C., the control unit 32 enters the engine side hot air supply mode (S115).

In the engine side hot air supply mode, the control unit 32 controls the flow control valve 26 and the water pump 28 of the cooling water circulation line 20 as shown in FIG. 4, thereby forming a cooling water circulation loop constituted by the heater core 22 and the engine 24 (S117). By way of the cooling water circulation loop thus formed, the waste heat of the engine 24 is transferred to the heater core 22 so that a hot air can be supplied into the passenger compartment (S119).

Therefore, the hot air can be supplied into the passenger compartment even when the refrigerant circulation line 10 is controlled in the air conditioner mode.

At this time, if the engine 24 is turned off, the control unit 32 turns on the engine 24. Therefore, the waste heat of the engine 24 can be transferred to the heater core 22.

### Second Embodiment

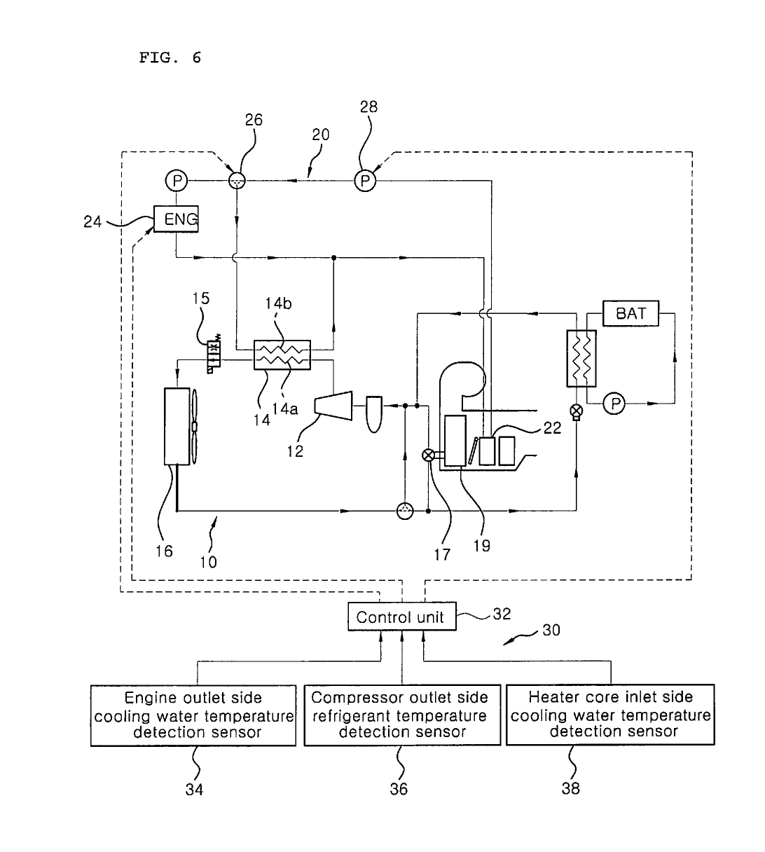

Next, a vehicular heat management system according to a second embodiment of the present invention will be described with reference to FIGS. 6 to 8.

Referring first to FIG. 6, the vehicular heat management system according to the second embodiment further includes a heater core inlet side cooling water temperature detection sensor 38 in addition to the components of the vehicular heat management system according to the first embodiment. The control unit 32 is configured to control the flow control valve 26, the engine 24 and the water pump 28 based on the temperature data inputted from the engine outlet side cooling water temperature detection sensor 34, the compressor outlet side refrigerant temperature detection sensor 36 and the heater core inlet side cooling water temperature detection sensor 38.

More specifically, when there is a need to supply a hot air into the passenger compartment, the control unit 32 compares the refrigerant discharge temperature inputted from the compressor outlet side refrigerant temperature detection sensor 36 with the cooling water introduction temperature inputted from the heater core inlet side cooling water temperature detection sensor 38.

If the result of comparison indicates that the refrigerant discharge temperature of the compressor 12 is equal to or higher than the cooling water introduction temperature of the heater core 22, the control unit 32 recognizes that a hot air can be supplied into the passenger compartment using the heat of the water-cooled heat exchanger 14.

When such recognition is made, the control unit 32 enters the heat pump side hot air supply mode to control the flow control valve 26 and the water pump 28 of the cooling water circulation line 20 to bring the water-cooled heat exchanger 14 of the refrigerant circulation line 10 into communication with the heater core 22.

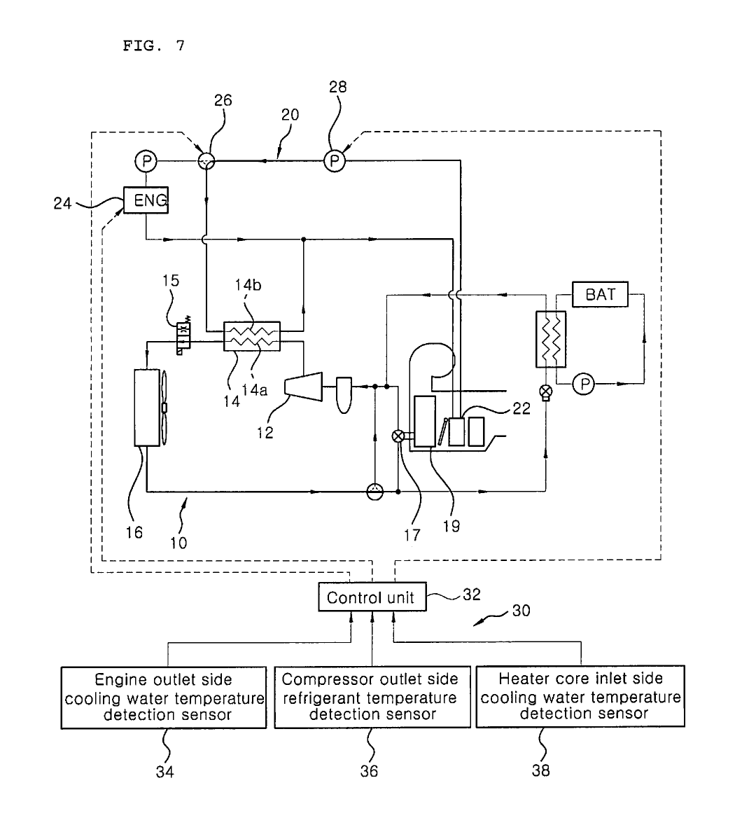

Therefore, as shown in FIG. 7, a cooling water circulation loop is formed between the heater core 22 and the water-cooled heat exchanger 14, the heat of the water-cooled heat exchanger 14 is transferred to the heater core 22 through the cooling water circulation loop, and a hot air is supplied into the passenger compartment using the heat of the water-cooled heat exchanger 14 transferred to the heater core 22.

Consequently, when there is a need to supply a hot air into the passenger compartment, the control unit 32 can supply the hot air into the passenger compartment without operating the engine 24. As a result, it is possible to minimize the operation of the engine 24 without deteriorating the comfort in the passenger compartment. This makes it possible to enhance the fuel efficiency of a vehicle and to improve the comfort in the passenger compartment.

It goes without saying that the compressor 12 of the refrigerant circulation line 10 has to be operated when the control unit 32 enters the heat pump side hot air supply mode.

In the process of supplying the hot air into the passenger compartment using the heat of the water-cooled heat exchanger 14, the control unit 32 continues to compare the cooling water discharge temperature inputted from the engine outlet side cooling water temperature detection sensor 34 with the cooling water introduction temperature inputted from the heater core inlet side cooling water temperature detection sensor 38.

If the result of comparison indicates that the cooling water discharge temperature of the engine 24 is equal to or higher than the cooling water introduction temperature of the heater core 22, the control unit 32 recognizes that it is more efficient to supply the hot air into the passenger compartment using the waste heat of the engine 24 than to supply the hot air into the passenger compartment using the heat of the water-cooled heat exchanger 14.

When such recognition is made, the control unit 32 enters the engine side hot air supply mode to control the flow control valve 26 and the water pump 28 of the cooling water circulation line 20 to bring the engine 24 into communication with the heater core 22.

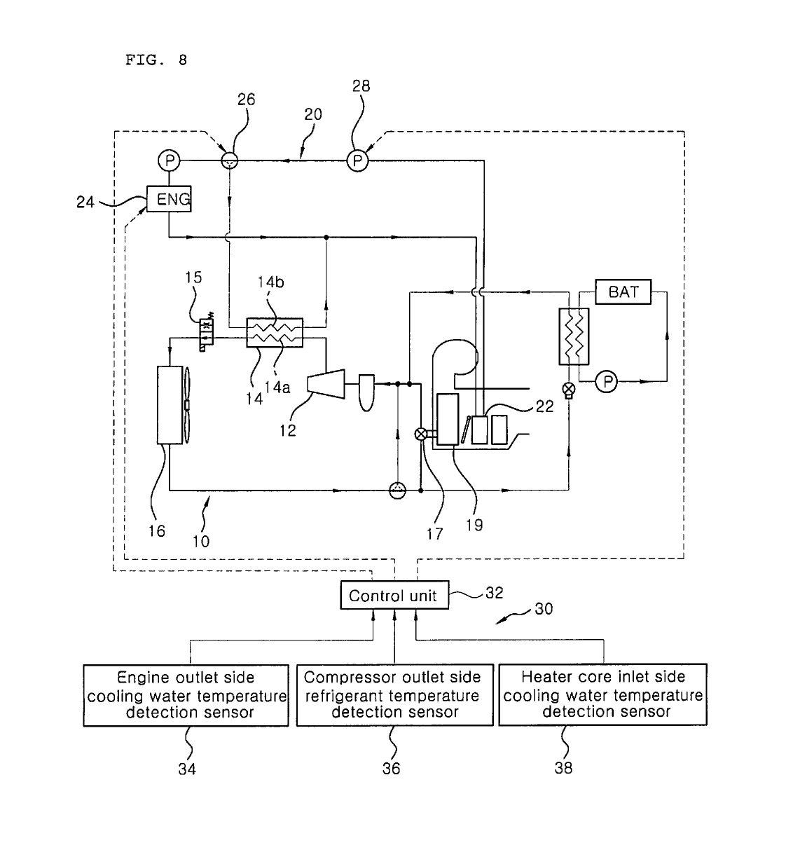

Therefore, as shown in FIG. 8, a cooling water circulation loop is formed between the heater core 22 and the engine 24, the waste heat of the engine 24 is transferred to the heater core 22 through the cooling water circulation loop, and a hot air is supplied into the passenger compartment using the waste heat of the engine 24 transferred to the heater core 22.

Consequently, the control unit 32 supplies a hot air into the passenger compartment using the waste heat of the engine 24 only when the temperature of the waste heat of the engine 24 is higher than the temperature of the heat of the water-cooled heat exchanger 14.

Accordingly, the use of the waste heat of the engine 24 can be minimized as far as possible. As a result, it is possible to enhance the fuel efficiency of a vehicle and to improve the comfort in the passenger compartment without deteriorating the comfort in the passenger compartment.

According to the vehicular heat management system having such a configuration, the hot air can be supplied into the passenger compartment during the air conditioner mode without operating the engine 24.

Furthermore, the operation of the engine 24 can be minimized without deteriorating the comfort in the passenger compartment.

In addition, it is possible to enhance the fuel efficiency of a vehicle and to improve the comfort in the passenger compartment.

While the preferred embodiments of the present invention have been described above, the present invention is not limited to the above-described embodiments. Various modifications and changes may be made without departing from the scope and spirit of the present invention defined in the claims.

What is claimed is:

1. A vehicular heat management system, comprising:
a refrigerant circulation line;
a cooling water circulation line configured to heat a passenger compartment with waste heat of an engine by allowing cooling water of the engine to circulate through a heater core; and
a hot air supply source selection unit configured to, when a hot air needs to be supplied into the passenger compartment in an air conditioner mode in which a refrigerant in the refrigerant circulation line flows through a compressor, an outdoor heat exchanger, an expansion valve and an indoor heat exchanger so as to cool the passenger compartment with cold air generated by the refrigerant in the indoor heat exchanger, select one of heat generated from the refrigerant in the compressor and heat generated from the cooling water in the engine, as a hot air supply source for supplying the hot air into the passenger compartment.

2. The system of claim 1, wherein the hot air supply source selection unit includes:
a water-cooled heat exchanger configured to transfer heat generated from the refrigerant having a high pressure and a high temperature in the compressor of the refrigerant circulation line to the cooling water of the cooling water circulation line;
a water pump and a flow control valve configured to generate a flow of the cooling water in the cooling water circulation line and to control the flow of the cooling water so that the waste heat of the engine is transferred to the heater core by allowing the cooling water to circulate between the engine and the heater core or so that the heat of the water-cooled heat exchanger is transferred to the heater core by allowing the cooling water to circulate between the water-cooled heat exchanger and the heater core; and
a control unit configured to control the water pump and the flow control valve so as to supply a hot air generated by the waste heat of the engine due to the circulation of the cooling water between the engine and the heater core or a hot air generated by the heat of the refrigerant circulation line due to the circulation of the cooling water between the water-cooled heat exchanger and the heater core, into the passenger compartment.

3. The system of claim 2, wherein the control unit is configured to control the water pump and the flow control valve so as to perform one of the supply of the hot air into the passenger compartment using the heat of the refrigerant circulation line and the supply of the hot air into the passenger compartment using the heat of the cooling water of the engine, according to a cooling water discharge temperature on an outlet side of the engine and a refrigerant discharge temperature on an outlet side of the compressor.

4. The system of claim 3, wherein the control unit is configured to control the water pump and the flow control valve so as to perform one of the supply of the hot air into the passenger compartment using the heat of the refrigerant circulation line and the supply of the hot air into the passenger compartment using the heat of the cooling water of the engine, according to a temperature difference between the cooling water discharge temperature and the refrigerant discharge temperature under a condition that the cooling water discharge temperature on the outlet side of the engine is equal to or lower than the refrigerant discharge temperature on the outlet side of the compressor.

5. The system of claim 4, wherein the control unit is configured to, if the temperature difference between the cooling water discharge temperature and the refrigerant discharge temperature exceeds a predetermined reference temperature difference, control the water pump and the flow control valve to allow the cooling water to circulate between the water-cooled heat exchanger and the heater core so that the heat of the refrigerant circulation line is used as the hot air supply source and, if the temperature difference between the cooling water discharge temperature and the refrigerant discharge temperature is equal to or smaller than the reference temperature difference, control the water pump and the flow control valve to allow the cooling water to circulate between the engine and the heater core so that the waste heat of the engine is used as the hot air supply source.

6. The system of claim 5, wherein the reference temperature difference is 10 degrees C.

7. The system of claim 2, further comprising:
an engine outlet side cooling water temperature detection sensor installed on an outlet side of the engine to detect a cooling water discharge temperature on an outlet side of the engine; and
a compressor outlet side refrigerant temperature detection sensor installed on an outlet side of the compressor to detect a refrigerant discharge temperature on an outlet side of the compressor.

8. The system of claim 2, wherein the control unit is configured to turn on the engine if the engine is turned off when the waste heat of the engine is used as the hot air supply source.

9. The system of claim 1, wherein when the passenger compartment is heated using the heat of the refrigerant in the compressor, the refrigerant discharged from the compressor is primarily condensed while passing through the water-cooled heat exchanger, secondarily condensed while passing through the outdoor heat exchanger, depressurized and expanded while passing through the expansion valve, configured to generate a cold air while passing through the indoor heat exchanger, and then returned to the compressor.

10. The system of claim 2, wherein the control unit is configured to control the water pump and the flow control valve so as to perform one of the supply of the hot air into the passenger compartment using the heat of the refrigerant circulation line and the supply of the hot air into the passenger compartment using the heat of the cooling water of the engine, according to a cooling water discharge temperature on an outlet side of the engine, a refrigerant discharge temperature on an outlet side of the compressor and a cooling water introduction temperature on an inlet side of the heater core.

11. The system of claim 10, wherein the control unit is configured to, if the cooling water discharge temperature is equal to or higher than the cooling water introduction temperature on the inlet side of the heater core, control the water pump and the flow control valve to allow the cooling water to circulate between the water-cooled heat exchanger and the heater core so that the heat of the refrigerant circulation line is used as the hot air supply source and, if the cooling water discharge temperature on the outlet side of the engine is equal to or higher than the cooling water introduction temperature on the inlet side of the heater core, control the water pump and the flow control valve to allow the cooling water to circulate between the engine and the heater core so that the waste heat of the engine is used as the hot air supply source.

12. The system of claim 10, further comprising:
an engine outlet side cooling water temperature detection sensor installed on the outlet side of the engine to detect the cooling water discharge temperature on the outlet side of the engine;
a compressor outlet side refrigerant temperature detection sensor installed on the outlet side of the compressor to detect the refrigerant discharge temperature on the outlet side of the compressor; and
a heater core inlet side cooling water temperature detection sensor installed on the inlet side of the heater core to detect the cooling water introduction temperature on the inlet side of the heater core.
